(19) United States
(12) Patent Application Publication
(10) Pub. No.: US 2020/0096140 A1
(43) Pub. Date: Mar. 26, 2020

(54) HOSE AND MANIFOLD FOR DISTRIBUTING HEATED EPOXY FOR SPRAY APPLICATION

(71) Applicant: Danny Warren, Carver, MA (US)

(72) Inventor: Danny Warren, Carver, MA (US)

(73) Assignee: Warren Environmental, Inc., Carver, MA (US)

(21) Appl. No.: 16/138,045

(22) Filed: Sep. 21, 2018

(51) Int. Cl. F16L 11/22; B05B 1/02; B05B 1/30

(52) U.S. Cl. CPC F16L 11/22; B05B 7/1404; B05B 1/3013; B05B 1/02

(57) ABSTRACT

A distribution system for delivering preheated epoxy material for spray application includes a bundle of lines that terminate on their far end in a manifold. The distribution system is uniquely constructed in a manner such that it delivers the correct materials individually to the manifold while maintaining separate flows of the materials. This separation of the materials until ready for spraying prevents mixing of the two-part epoxy which at the elevated delivery temperatures would result in early curing of the epoxy within the delivery system itself. The bundle of lines contains at least one and preferably two base epoxy delivery lines, at least one catalyst delivery line and at least one heating circuit. The manifold terminates in a static mixer that in turn delivers the mixed epoxy to a spray head for spray application to the substrate.

### BACKGROUND OF THE INVENTION

The present invention relates generally to a system for the distribution of heated epoxy materials for spray application. More specifically, the present invention is directed to a hose and manifold arrangement to distribute the various components of epoxy materials to a mixing system thereby facilitating spray application thereof.

Generally, epoxy coatings are well known in the art and due to their exceptional durability and structural properties epoxy based protective coatings have gained commercial acceptance as protective and decorative coatings for use on a wide variety of materials. For example, epoxy based protective coatings represent one of the most widely used methods of corrosion control. They are used to provide long term protection of steel, concrete, aluminum and other structures under a broad range of corrosive conditions, extending from atmospheric exposure to full immersion in highly corrosive environments. Further, epoxy coatings are readily available and are easily applied by a variety of methods including spraying, rolling and brushing. They adhere well to steel, concrete and other substrates, have low moisture vapor transmission rates and act as barriers to water, chloride and sulfate ion ingress, provide excellent corrosion protection under a variety of atmospheric exposure conditions and have good resistance to many chemicals and solvents. As a result, numerous industries including maintenance, marine, construction, architectural, aircraft and product finishing have adopted broad usage of epoxy coating materials.

The most common material utilized in the epoxy coating industry today is a multi-part epoxy material. In general, the epoxy includes a first base resin matrix and at least a second catalyst or hardener, although other components such as a pigment agent or an aggregate component may also be added. While the two parts remain separate, they remain in liquid form. After the two parts are mixed together, they begin a curing process that is typically triggered by exposure to heat, humidity or a ultra-violet light source, whereby the mixed material quickly begins to solidify. The resin base and the catalyst are typically highly viscous in consistency and when mixed, generally having a paste like consistency.

The difficulty found in the prior art is that while epoxy has highly desirable characteristics as a finished coating, the preferred method of application is spray application. When attempting to spray apply an epoxy, two drawbacks are encountered. First, the material cannot be mixed in large batches prior to application because of the short pot life of the material. Accordingly, it must be mixed on an as needed basis immediately prior to spray application. Second, the naturally viscous consistency of the mixed epoxy material is not well suited for spray application. To thin the epoxy to the consistency required for typical prior art spray application, the epoxy must be loaded with a large percent by volume of solvent. Such a solvent typically contains high level of volatile organic compounds (VOC) whose primary function is to lower viscosity thereby providing a consistency suitable for spray application with conventional air, airless and electrostatic spray equipment. The addition of the solvent to the epoxy coating material in turn greatly increases the VOC content of the epoxy coating material and reduces the build thickness of the finished and cured coating.

In view of the above, the problem with spray application of epoxy coating materials becomes two-fold. First, there is a growing emphasis on compliance with government environmental and health hazard regulations, which in turn has prompted coating material manufacturers and end users to evaluate new coating technologies. The Clean Air Act sets limits on both the type and amount of VOC content found in coating materials and has resulted in research directed to higher solids, solventless and waterborne protective coating systems. As a result of such research, the newer epoxy materials are either highly viscous resulting in a poor-quality finish when spray applied or too thin to produce the type of high build coating that is normally expected from spray applied epoxy coatings.

While many processes and techniques have been proposed in the prior for the spray application of epoxy coating materials to substrates, prior art spray processes are directed to the reduction of material viscosity through the use of solvents. In most cases, such spray operations operate with materials having a low viscosity on the order of 100 poise and utilize a relatively low application pressure on the order of no more than about 100 psi.

Therefore, there is a need for a system for the distribution of high molecular weight, highly viscous polymeric thermally cured materials at elevated temperature in a manner that facilitates spray application thereof. There is a further need for a system for the distribution of epoxy coating materials that eliminates or reduces the need for solvent loading while also providing a mixed epoxy product that has a consistency that is suitable for spray application. There is still a further need for a system for spray applying an epoxy material that is capable of continuous duty wherein a low viscosity epoxy can be spray applied without a high level of equipment down time or recycling time. Simply stated, the art is devoid of any proven technique for spraying high molecular weight epoxy coating materials of this character.

### BRIEF SUMMARY OF THE INVENTION

In this regard, the present invention provides for a system for the continuous delivery of epoxy material that is capable of reducing the viscosity of the epoxy materials in preparation of spray application without the need of thinning through the addition of VOC solvents. In the method and system of the present invention the component parts of the epoxy material are preheated before they are mixed, thereby achieving a large reduction in the material viscosity without requiring thinning of the material or the addition of solvents.

The present invention provides for a heating tank system that operates as a reservoir for containing and preheating the epoxy materials in preparation for delivery, mixing and spray application. A distribution system includes a bundle of lines that terminate on their far end in a manifold. The distribution system is uniquely constructed in a manner such that it delivers the correct materials individually to the manifold while maintaining separate flows of the materials. This separation of the materials until ready for spraying prevents mixing of the two part epoxy which at the elevated delivery temperatures would result in early curing of the epoxy within the delivery system itself.

The bundle of lines contains at least one and preferably two base epoxy delivery lines, at least one catalyst delivery line and at least one heating circuit. Preferably the hose bundle may also include additional lines to facilitate improvement of the heating circuit, a solvent delivery line, a solvent recovery line, and/or a compressed air line. The bundle of lines terminates at a manifold that facilitates switching between various operations including spray operation, stand by mode, recirculation, cleaning and the like. The manifold terminates in a static mixer that in turn delivers the mixed epoxy to a spray head for spray application to the substrate.

It is important to note that in the preferred embodiment of the present invention, the heating of the resin takes place in a closed environment while heating the resin to the desired application temperature. In this manner, if evaporation of any of the chemical components of the resin does occur, it is fully contained, and all of the resin components are transferred intact to the mixing nozzle. Similarly, if the catalyst were heated to the target temperature range in an open container, some of the components, such as ammonia, that are in the catalyst would evaporate creating problems in the finished product. Since the catalyst cannot be heated in an open chamber the catalyst is also heated within a closed environment and fully contained before mixing, as will be discussed in detail below, to also preheat the catalyst to the desired temperature range.

In one embodiment, the bundle of lines contains one catalyst line and two base resin lines wherein the size and delivery pressure of all three lines is matched such that the mixing ratio of resin to catalyst at the static mixer is maintained at an ideal 2:1.

In another embodiment, a bypass between a first resin line and a second resin line allows a recirculation option that facilitates keeping the resin within the lines hot and at a low viscosity during periods when not actively spraying.

In another embodiment a solvent delivery line is provided so that cleaning solvents can be distributed to the end of the manifold, static mixer and spray head for the cleaning thereof. It is preferred in this embodiment that a compressed air line is also provided so as to purge the solvent line after the cleaning operation is completed.

The method and system of the present invention therefore provides a delivery system for a two-part epoxy mixture that is preheated and has a viscosity that is sufficiently low for spray application without the need for the addition of solvent. The resulting coating has an improved build and a higher structural value as compared to epoxies that were applied using the prior art systems and methods.

It is therefore an object of the present invention to provide a method and system for the spray application of epoxy coating material. It is a further object of the present invention to provide a method and system for the spray application of epoxy coating material while eliminating the need for thinning the material with VOC solvents. It is yet a further object of the present invention to provide a method and system for the spray application of epoxy coating material by preheating the component parts of the material in a closed environment before combining and mixing the component parts thereby achieving a reduction in the viscosity of the epoxy material without the need for the addition of VOC solvents. It is still a further object of the present invention to provide a method and system for spray application of epoxy material that is capable of delivering the material for spray application in a manner that substantially reduces the material viscosity while also being capable of near continuous operational duty.

These together with other objects of the invention, along with various features of novelty, which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a perspective view of an illustrative embodiment of a system for the spray application of epoxy material in accordance with the disclosure of the present invention.

### DETAILED DESCRIPTION OF THE INVENTION

Now referring to the drawings, a preferred embodiment of the system for spray application of epoxy coating materials is shown and generally illustrated at 10 in the FIGURES. It is important to understand that while this preferred embodiment is shown for the purpose of illustration, the system and method of the present invention may be accomplished by using many different structural variations that are still intended to be covered within the scope of the present invention. Further, for purposes of the present application, the term “spray application” refers to breakup of the material into small particles or droplets that are broadcast onto a substrate in a pattern, such as a fan, sheet or cone pattern, that has a width at the point of deposition on the substrate that is many times the diameter of the spray nozzle opening. Spray application is therefore defined in a manner that is to be distinguished from “flowing” or “extruding” where the material at the point of deposition has a dimension that is about the same a the dimension of the opening. Accordingly, as discussed above, the present invention is directed to a method and system for spray application of high molecular weight polymeric epoxy materials, such as structural epoxy, that handles the material at application temperature and pressure without requiring solvents or the like to reduce viscosity.

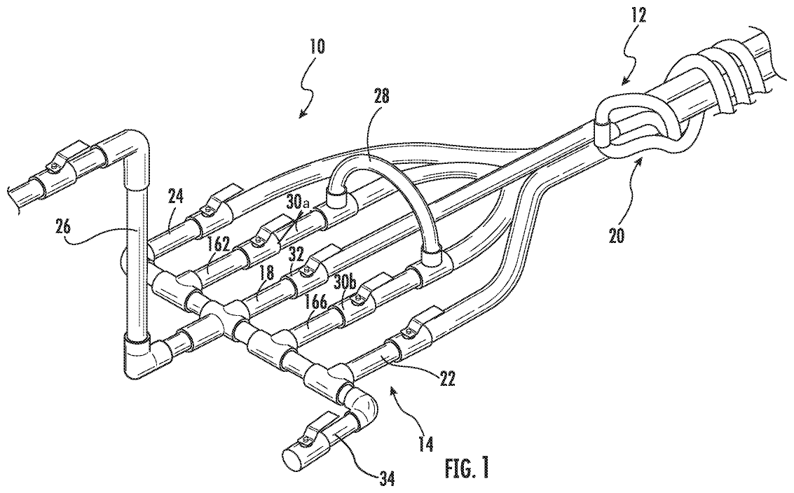

The present invention provides for a heating tank system that operates as a reservoir for containing and preheating the epoxy materials in preparation for delivery, mixing and spray application. As can be seen in FIG. 1, a distribution system shown generally at reference 10 includes a bundle of lines shown generally at 12 that terminate on their far end in a manifold 14. The distribution system 10 is uniquely constructed in a manner such that it delivers the correct materials individually to the manifold 14 while maintaining separate flows of the materials prior to mixing immediately before application. This separation of the materials until ready for spraying prevents mixing of the two-part epoxy which at the elevated delivery temperatures would result in early curing of the epoxy within the delivery system itself.

Now discussing the bundle of lines 12 in detail, in one embodiment the bundle of lines 12 contains at least one and preferably two base epoxy delivery lines 16a and 16b, at least one catalyst delivery line 18 and at least one heating circuit line 20. Preferably the bundle of lines 12 may also include additional lines to facilitate improvement of the heating circuit 20, a solvent delivery line 22, a solvent recovery line, and/or a compressed air line 24. The bundle of lines 12 terminates at a manifold 14 that facilitates switching between various operations including spray operation, standby mode, recirculation, cleaning and the like. The manifold 14 directs the material flow to a static mixer 26 that in turn delivers the mixed epoxy to a spray head for spray application to the substrate. Further, the manifold 14 includes a plurality of valves that will be discussed in further detail below that regulate the material flow for controlling the operational modes of the distribution system 10.

It should be noted that, while a certain number and configuration of lines are shown, this arrangement is meant to be illustrative and not limiting to the system or operation thereof. A variety of embodiments may be employed that appear or are arranged differently from the specific one illustrated herein and still fall within the scope of the claims. For example, rather than employing two resin lines 16a and 16b, the system could instead use a single resin line of a larger diameter that provides a flow rate that is exactly double the flow rate of the catalyst line 18. Similarly, the order or relative positioning of the lines, the valves and the configuration of the manifold may be altered provided the operational principal remains the same.

It is important to note that in the preferred embodiment of the present invention, the heating of the resin takes place in a closed environment while heating the resin to the desired application temperature. In this manner, if evaporation of any of the chemical components of the resin does occur, it is fully contained, and all of the resin components are transferred intact to the static mixer 26. Similarly, if the catalyst were heated to the target temperature range in an open container, some of the components, such as ammonia, that are in the catalyst would evaporate creating problems in the finished product. Since the catalyst cannot be heated in an open chamber the catalyst is also heated within a closed environment and fully contained before mixing.

It can be preferably seen that the bundle of lines contains one catalyst line 18 and two base resin lines 16a and 16b. The diameter of the catalyst line 18 and the two resin lines 16a and 16b are preferably matched. In this manner, the two resin lines 16a and 16b deliver exactly twice the volume of material than is delivered by the catalyst line 18. Since the size and delivery pressure of all three lines is matched, this insures that the mixing ratio of resin to catalyst at the static mixer 26 is maintained at an ideal 2:1. It should be noted that this can be accomplished in other configurations and while described specifically here in one embodiment, one skilled in the art can appreciate that the use of additional lines or different sized lines will achieve the same material delivery goal. Further, one skilled in the art can appreciate that if other materials require different mixing ratios such as 1:1 or 3:1 or 4:4 or the like, the size and number of lines can be varied to create the needed material delivery in order to facilitate the mixing of resin and catalyst at those other ratios.

In another embodiment, a bypass 28 between a first resin line 16a and a second resin line 16b allows a recirculation option that facilitates keeping the resin within the lines hot and at a low viscosity during periods when not actively spraying. During periods where the spraying system is inactive such as overnight periods, valves 30a and 30b on resin lines 16a and 16b respectively can be closed. By closing valves 30a and 30b and stopping the active pumping of resin on line 16b, a recirculation loop is created such that resin flowing within the resin lines 16a and 16b is continuously flowing despite the spray system being inactive. By recirculating the resin, the resin remains as an elevated temperature and at a reduced viscosity. This prevents the resin from standing in lines 16a and 16b, cooling and thickening such that the system is not immediately operable upon start up after idle periods. It should also be appreciated that valves 30a and 30b may be manual such that an operator can regulate them, automatic such that they may be remotely controlled or a combination thereof.

In another embodiment a solvent delivery line 22 is provided so that cleaning solvents can be distributed to the end of the manifold 14, static mixer 26 and spray head for the cleaning thereof. It is preferred in this embodiment that a compressed air line 24 is also provided so as to purge the solvent line 22 after the cleaning operation is completed. This is done because leaving solvent pressurized within the solvent delivery line 22 has created problems in the past when the line has been damaged or punctured spraying pressurized solvent into confined spaces. Further, at one of the manifold 14, a blow off valve/fitting 34 may be provided to facilitate solvent circulation and recovery during cleaning operations and allow an outlet for blowing out or clearing of mixed epoxy material from the manifold end of the system leaving it clean an ready for operation.

It is important to note that in the preferred embodiment of the present invention the resin and catalyst are both heated separately and transmitted along the distribution line bundle 12 before they are mixed. In the prior art, when the two parts were mixed prior to heating, the applicator was faced with a tank full of activated material that has a relatively short pot life before hardening. Further, at the end of the application, any mixed material remaining in the tank was wasted. The present invention provides for the two components to be heated separately and then mixed thereby requiring that only the epoxy material that is needed be mixed.

Another important feature of the present invention is that the resin is in a closed environment while heating it to the desired application temperature of between approximately 150° F. and 160° F. In this manner, even if evaporation does occur, it is fully contained, and all of the resin components are transferred intact to the mixer 26. Similarly, if the catalyst were heated to the target temperature range of between approximately 150° F. and 160° F. using the same method in an open container, some of the components, such as ammonia, that are in the catalyst would evaporate creating problems in the finished product. Since the catalyst cannot be heated in an open chamber the catalyst is also heated within a closed environment to the desired temperature range.

It should be noted that the line bundle 12 may extend several hundreds of feet into a tunnel or pipeline that is being coated. In order to prevent cooling of the materials being distributed through the various lines in the bundle 12, at least one circuit of heating lines 20 is provided. The heating lines may be electric resistance heaters. Preferably, the heating lines are distribution tubes that carry a continuous flow of heated fluid therein. Such heated fluid may be water, glycol, saline, brine or a mixture thereof. The heating lines 20 may be a circuit of a supply line and a return line or may include more that one supply and/or return as needed to maintain the proper operating temperature of the system.

The method and system of the present invention therefore provides a delivery system for a two-part epoxy mixture that is preheated and has a viscosity that is sufficiently low for spray application without the need for the addition of solvent. The resulting coating has an improved build and a higher structural value as compared to epoxies that were applied using the prior art systems and methods.

It can be seen that the present invention provides a method and system for the spray application of epoxy coating material. It can be further seen that the present invention provides a method and system for the spray application of epoxy coating material while eliminating the need for thinning the material with VOC solvents. Still further it can be seen that the present invention provides a method and system for the spray application of epoxy coating material by preheating the component parts of the material in a closed environment before combining and mixing the component parts thereby achieving a reduction in the viscosity of the epoxy material without the need for the addition of VOC solvents. Still further, the present invention provides a method and system for spray application of epoxy material that is capable of delivering the material for spray application in a manner that substantially reduces the material viscosity while also being capable of near continuous operational duty. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A system for the spray application of a multi-part epoxy material, said multi-part epoxy material including at least a resin and a catalyst, said system comprising:
a bundle containing at least one resin distribution line and at least one catalyst distribution line;
a manifold having an input and an output, said input in fluid communication with said bundle; and
a static mixer at said output of said manifold to mix and direct a flow of said multi-part epoxy material to a spray applicator.

2. The system of claim 1, said bundle further comprising:
two resin distribution lines.

3. The system of claim 2, further comprising:
a bypass loop extending between said two resin distribution lines.

4. The system of claim 1, further comprising valves on each of said lines within said bundle, said valves positioned before said manifold.

5. The system of claim 4, wherein said valves are selected from the group consisting of: manual valves, electric valves and remotely operated valves.

6. The system of claim 3, further comprising valves on each of said lines within said bundle, said valves positioned before said manifold.

7. The system of claim 1, said bundle further comprising:
a solvent delivery line.

8. The system of claim 1, said bundle further comprising:
a compressed air delivery line.

9. The system of claim 1, wherein the resin is heated to between approximately 150° F. and 160° F. as it flows through said resin delivery line.

10. The system of claim 1, wherein the catalyst is heated to between approximately 150° F. and 160° F. as it flows through said catalyst delivery line.

10. The system of claim 1, further comprising a heating element adjacent said bundle to heat said resin and said catalyst delivery lines.

11. The system of claim 10, wherein said heating element is wrapped around said bundle.

12. The system of claim 1, said manifold further comprising:
a blow off valve.

12. A system for the spray application of a multi-part epoxy material, said multi-part epoxy material including at least a resin and a catalyst, said system comprising:
a bundle containing at least one resin distribution line and at least one catalyst distribution line, wherein a flow rate of said resin lines is calibrated relative to a flow rate of said catalyst line to deliver a specific resin to catalyst ratio;
a manifold having an input and an output, said input in fluid communication with said bundle; and
a static mixer at said output of said manifold to mix and direct a flow of said multi-part epoxy material to a spray applicator.

13. The system of claim 12, said bundle further comprising:
two resin distribution lines, said resin to catalyst ratio being 2:1.

14. The system of claim 13, further comprising:
a bypass loop extending between said two resin distribution lines.

15. The system of claim 12, said bundle wherein a cross sectional area of said resin distribution line is twice a cross sectional area of said catalyst distribution line, said resin to catalyst ratio being 2:1.

16. The system of claim 12, said bundle further comprising:
a solvent delivery line.

17. The system of claim 12, said bundle further comprising:
a compressed air delivery line.

18. The system of claim 12, further comprising a heating element adjacent said bundle to heat said resin and said catalyst delivery lines.

19. The system of claim 19, wherein said heating element is wrapped around said bundle.
